(19) United States
(12) Patent Application Publication
(10) Pub. No.: US 2026/0199190 A1
(43) Pub. Date: Jul. 16, 2026

(54) ANTI-COLIC NIPPLE

(71) Applicant: XIAMEN MODERN DELTA LTD., Xiamen (CN)

(72) Inventor: KWEI-TSWEN KUO, Xiamen (CN)

(73) Assignee: XIAMEN MODERN DELTA LTD., Xiamen (CN)

(21) Appl. No.: 19/079,546

(22) Filed: Mar. 14, 2025

(30) Foreign Application Priority Data
Jan. 16, 2025 (CN) 202520100986.3

(51) Int. Cl. A61J 11/00; A61J 11/02

(52) U.S. Cl. CPC A61J 11/002; A61J 11/004; A61J 11/0065; A61J 11/02

(57) ABSTRACT

The present invention provides an anti-colic nipple. The anti-colic nipple is used with a feeding bottle and includes a nipple and a vent tube, the nipple is provided with an air inlet, the air inlet penetrates through the nipple, the vent tube is integrally formed below the nipple, an upper end portion of the vent tube is an air inlet end, the air inlet end communicates with the air inlet, a lower end portion of the vent tube is an air outlet end, the air outlet end extends to a bottom of the feeding bottle, and at least one one-way air outlet is provided on a circumferential side surface of the air outlet end of the vent tube. Therefore, the anti-colic nipple of the present invention has good sealing performance and a good anti-colic effect.

### RELATED APPLICATIONS

The present patent document claims the benefit of priority to Patent Application No. 202520100986.3, filed January 16, 2025, and entitled “ANTI-COLIC NIPPLE,” the entire contents of each of which are incorporated herein by reference.

### BACKGROUND

### Technical Field

The present invention relates to the technical field of nursing products, and more specifically, to an anti-colic nipple.

### Background Information

A conventional anti-colic method for a nipple involves providing an air inlet on the nipple. When an infant sucks the nipple, the internal pressure of a feeding bottle decreases. Under the action of difference between the internal pressure and external pressure of the feeding bottle, air enters the feeding bottle via the air inlet, balancing the internal pressure and external pressure of the feeding bottle and facilitating the infant's sucking. However, during use of such nipple, the cavity of the nipple is often filled up with milk. Air entering the feeding bottle via the air inlet may come into contact with the milk, generating bubbles and introducing air into the milk. This causes the infant to ingest air, leading to colic. To address this, there is another anti-colic feeding bottle available on the market, including a nipple with an air inlet, and a vent tube that is assembled below the nipple and communicates with the air inlet. A bottom end of the vent tube is provided with an air outlet. When the infant drinks milk, the vent tube directs air into the bottom of the feeding bottle, equalizing the internal pressure and external pressure of the feeding bottle. However, during practical use, when the vent tube directs air to the bottom of the bottle, the air outlet at the bottom end of the vent tube may be pressed against an inner wall of the feeding bottle, which may cause the air outlet to be forced open by the milk entering the vent tube. It may also cause the inner wall of the feeding bottle to block the air outlet, resulting in poor airflow and failure to balance the internal pressure and external pressure of the feeding bottle. Additionally, there may be issues with poor sealing performance, causing the bottle to be susceptible to external contamination.

In addition, in the anti-colic nipple with a vent tube currently available on the market, the vent tube and the nipple are typically separate structures, requiring another anti-colic device for combination use. During use, the vent tube and other components need to be assembled onto the nipple one by one. However, the separate structures, due to the many components, are relatively complex and cumbersome to operate. During cleaning, each component needs to be cleaned individually, causing inconvenience in use.

### BRIEF SUMMARY

An objective of the present invention is to provide an anti-colic nipple with good sealing performance and desirable effects.

To achieve the foregoing objective, the present invention provides an anti-colic nipple. The anti-colic nipple is used with a feeding bottle and includes a nipple and a vent tube, where the vent tube and the nipple are of an integrated structure, the vent tube is integrally formed below the nipple, the nipple is provided with an air inlet, the air inlet penetrates through the nipple, an upper end portion of the vent tube is an air inlet end, the air inlet end communicates with the air inlet, a lower end portion of the vent tube is an air outlet end, the air outlet end extends to a bottom of the feeding bottle, and at least one one-way air outlet is provided on a circumferential side surface of the air outlet end of the vent tube.

Further, the one-way air outlet is an elongated side seam provided on the circumferential side surface of the air outlet end of the vent tube.

Further, two one-way air outlets are provided.

Further, the two one-way air outlets are symmetrically provided on the circumferential side surface of the air outlet end of the vent tube.

Further, the nipple and the vent tube are both made of a silicone material.

Further, hardness of the vent tube is greater than hardness of the nipple.

Further, an inner cavity of the nipple is provided with a reinforcing rib for shaping.

Further, an outer circumferential side of the nipple is provided with a thickened section thicker than the other part.

After the use of the above solution, the present invention at least has the following technical effects:

1. Because the nipple and the vent tube are integrally formed, the nipple has good sealing performance and is less likely to be contaminated, and the vent tube has a good air guiding effect. The air introduced into the feeding bottle does not leak out via a joint between the vent tube and the nipple, resulting in a good anti-colic effect.

2. Because the nipple and the vent tube are of a simple integrated structure, during use of the anti-colic nipple of the present invention, no additional assembly steps are required. Compared with the separate structures in the prior art, the integrated structure is simpler and more convenient to operate, and easier to clean.

3. The one-way air outlet of the vent tube is provided on the circumferential side surface of the air outlet end of the vent tube, avoiding the problem of the one-way air outlet being blocked or forced open due to contact with or press against the inner wall of the feeding bottle when the vent tube is in the feeding bottle.

### BRIEF DESCRIPTION OF THE DRAWINGS

FIG. 1 is a structural three-dimensional diagram according to the present invention.

FIG. 2 is a structural three-dimensional diagram at another view of angle according to the present invention.

FIG. 3 is an enlarged view of a one-way air outlet according to the present invention.

FIG. 4 is a sectional view according to the present invention.

### Description of Reference Numerals

1. nipple; 11. air inlet; 12. reinforcing rib; 13. thickened section; 2. vent tube; 21. air inlet end; 22. middle section; 23. air outlet end; and 231. one-way air outlet.

### DETAILED DESCRIPTION OF THE DRAWINGS AND THE PRESENTLY PREFERRED EMBODIMENTS

In order to further explain the technical solutions of the present invention, the following describes the present invention in detail with reference to a specific embodiment.

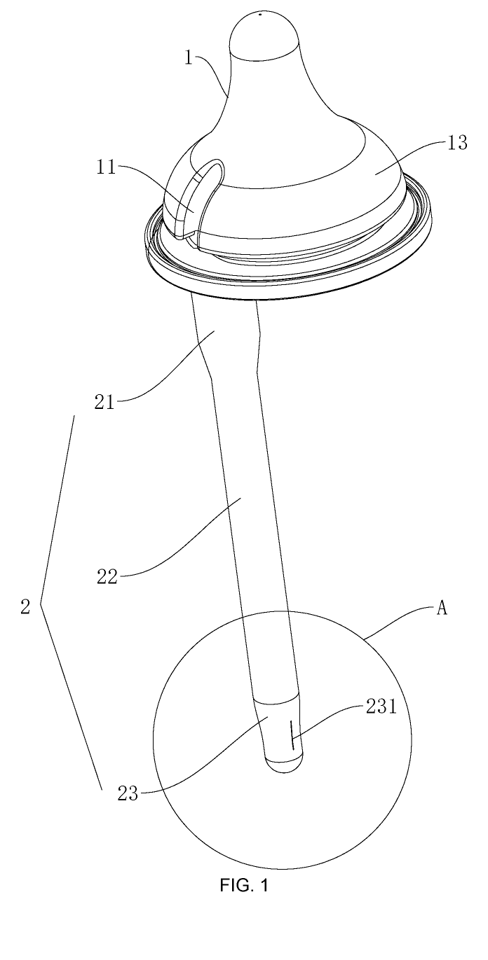

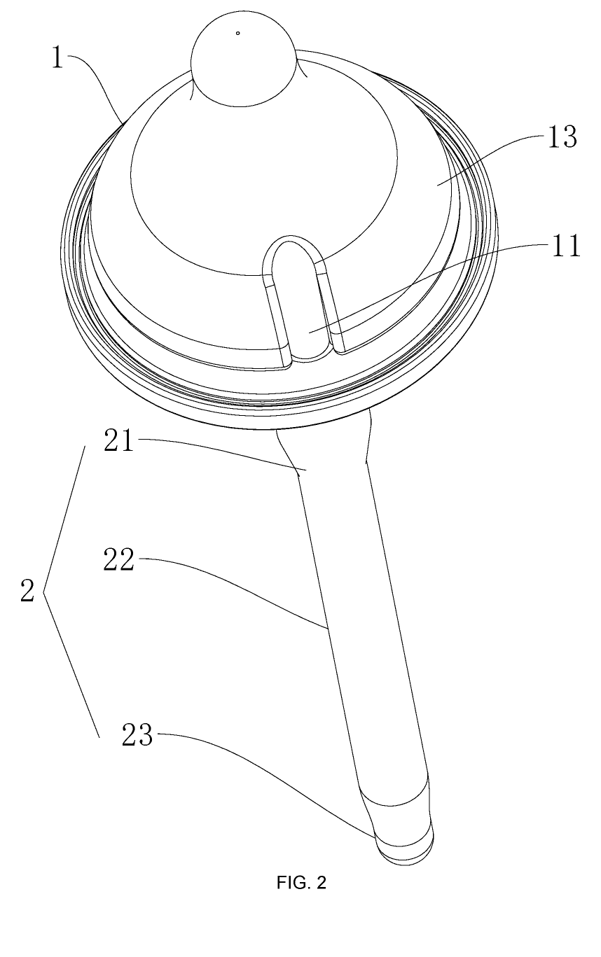

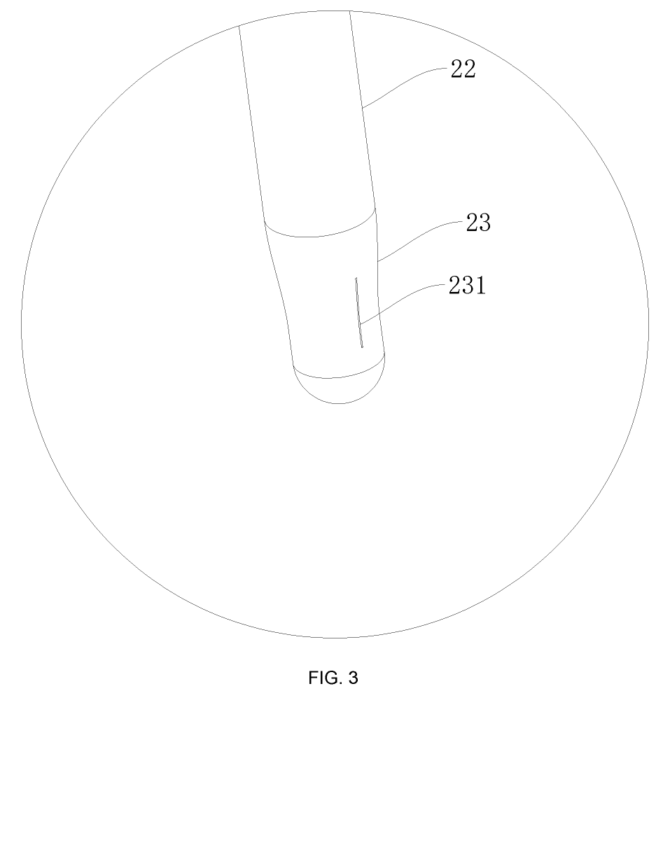

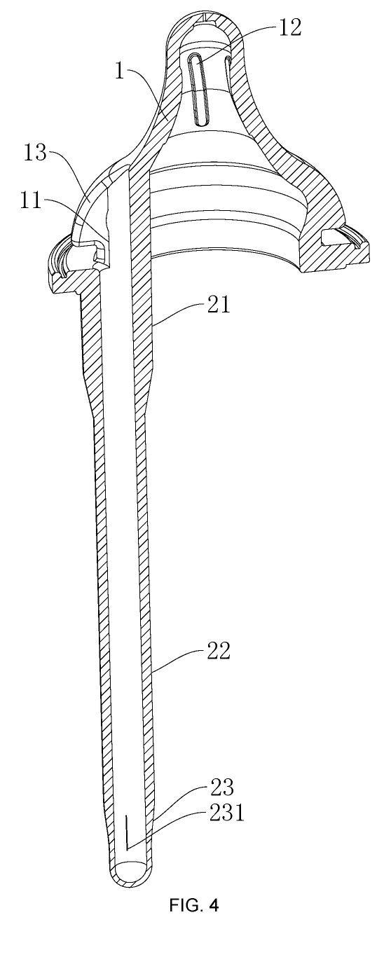

Referring to FIGS. 1 to 4, the present invention discloses an anti-colic nipple. The anti-colic nipple may be used with a feeding bottle. The anti-colic nipple of the present invention includes a nipple 1 and a vent tube 2. The vent tube 2 is integrally formed below the nipple 1, and the vent tube 2 and the nipple 1 are of an integrated structure. The nipple 1 is provided with an air inlet 11, the air inlet 11 penetrates through the nipple 1, an upper end portion of the vent tube 2 is an air inlet end 21, the air inlet end 21 communicates with the air inlet 11, a lower end portion of the vent tube 2 is an air outlet end 23, the air outlet end 23 extends to a bottom of the feeding bottle, and at least one one-way air outlet 231 is provided on the circumferential side surface of the air outlet end 23 of the vent tube 2.

In this embodiment, the vent tube 2 and the nipple 1 are of a simple integrated structure. During use, the anti-colic nipple of this embodiment can be directly assembled onto the feeding bottle without additional assembly steps, and after use, only the anti-colic nipple and the feeding bottle need to be cleaned separately, providing convenience in use.

When milk is loaded into the feeding bottle assembled with the anti-colic nipple of the present invention, the internal pressure and external pressure of the feeding bottle are consistent, the one-way air outlet 231 is closed, and the milk does not enter the one-way air outlet 231 and flows out through the air inlet 11. When the feeding bottle is in use, as the infant sucks, the amount of milk in the feeding bottle decreases, and the internal pressure of the feeding bottle decreases. Under the action of external atmospheric pressure, the one-way air outlet 231 opens, balancing the internal pressure and external pressure of the feeding bottle, such that the milk can be more easily squeezed out of the nipple 1. The vent tube 2 and the nipple 1 are integrally formed by a mold, ensuring good sealing performance and a good air guiding effect. When the feeding bottle is in use, the feeding bottle is usually inverted, and the bottom of the feeding bottle is quickly devoid of milk, making it difficult for milk to enter the vent tube 2. This embodiment differs from the prior art in that the one-way air outlet 231 of the air outlet end 23 of the vent tube 2 is arranged on the circumferential side surface of the vent tube 2, rather than at the bottom of the vent tube 2. This can effectively prevent the one-way air outlet 231 from being blocked by or forced open due to contact with the inner wall of the feeding bottle, which otherwise affects the air guiding effect or causes milk to enter the vent tube 2.

In this embodiment, the one-way air outlet 231 is an elongated side seam provided on the circumferential side surface of the air outlet end 23 of the vent tube 2. It can be formed by directly cutting a strip-shaped incision on the circumferential side surface of the vent tube 2. Two one-way air outlets 231 may be provided, and the two one-way air outlets 231 are symmetrically provided on the circumferential side surface of the air outlet end 23 of the vent tube 2, which can further ensure the ventilation function of the one-way air outlets 231.

In this embodiment, the nipple 1 and the vent tube 2 are both made of silicone material, and hardness of the vent tube 2 is greater than hardness of the nipple 1.

Preferably, an inner cavity of the nipple 1 is provided with multiple reinforcing ribs 12 for shaping, and the multiple reinforcing ribs 12 are arranged around the inner cavity of the nipple 1.

Preferably, an outer circumferential side of the nipple 1 is provided with a thickened section 13 thicker than the other part, making the nipple 1 less prone to deformation and damage.

In this embodiment, the shape of the vent tube 2 is as follows: the air inlet end 21 communicating with the air inlet 11 is the thickest (indicating the largest diameter), the air inlet end 21 tapers downwards to be a second thickest middle section 22, and a lower end of the middle section 22 tapers downwards to be the thinnest air outlet end 23. This reduces not only materials but also space within the feeding bottle.

The above is only one embodiment of the present invention and is not intended to limit the present invention. Any modifications, equivalent replacements, and improvements made within the spirit and principles of the present invention should be included within the scope of protection of the present invention.

1. An anti-colic nipple, wherein the anti-colic nipple is used with a feeding bottle and comprises a nipple and a vent tube, the vent tube and the nipple are of an integrated structure, the vent tube is integrally formed below the nipple, the nipple is provided with an air inlet, the air inlet penetrates through the nipple, an upper end portion of the vent tube is an air inlet end, the air inlet end communicates with the air inlet, a lower end portion of the vent tube is an air outlet end, the air outlet end extends to a bottom of the feeding bottle, and at least one one-way air outlet is provided on a circumferential side surface of the air outlet end of the vent tube.

2. The anti-colic nipple according to claim 1, wherein the one-way air outlet is an elongated side seam provided on the circumferential side surface of the air outlet end of the vent tube.

3. The anti-colic nipple according to claim 1, wherein two one-way air outlets are provided.

4. The anti-colic nipple according to claim 3, wherein the two one-way air outlets are symmetrically provided on the circumferential side surface of the air outlet end of the vent tube.

5. The anti-colic nipple according to claim 1, wherein the nipple and the vent tube are both made of a silicone material.

6. The anti-colic nipple according to claim 5, wherein hardness of the vent tube is greater than hardness of the nipple.

7. The anti-colic nipple according to claim 1, wherein an inner cavity of the nipple is provided with a reinforcing rib for shaping.

8. The anti-colic nipple according to claim 1, wherein an outer circumferential side of the nipple is provided with a thickened section thicker than the other part.

9. The anti-colic nipple according to claim 1, wherein the air inlet end of the vent tube communicating with the air inlet is the thickest, the air inlet end tapers downwards to be a second thickest middle section, and a lower end of the middle section tapers downwards to be the thinnest air outlet end.
